(19) United States
(12) Patent Application Publication
(10) Pub. No.: US 2024/0359922 A1
(43) Pub. Date: Oct. 31, 2024

(54) REINFORCEMENT SYSTEM AND METHOD FOR SUPPORTING STACKED BOXES AND CONTAINERS

(71) Applicant: Roberto Tomás Stanley Calvo, Santiago (CL)

(72) Inventor: Roberto Tomás Stanley Calvo, Santiago (CL)

(21) Appl. No.: 18/682,777

(22) PCT Filed: Sep. 14, 2021
(86) PCT No.: PCT/CL2021/050085

§ 371 Date: Feb. 9, 2024

(30) Foreign Application Priority Data
Sep. 9, 2021 (CL) 2364-2021

(51) Int. Cl. B65G 1/14

(52) U.S. Cl. CPC B65G 1/14

(57) ABSTRACT

The present invention relates to a reinforcement system and method for supporting stacked containers or boxes, without resulting in damage to the contents and the containers themselves. The system comprises at least one pillar element (1) and at least one end shoulder element (2), where the at least one pillar element (1) is arranged in at least one corner of the stack formed by the containers, and where the at least one end shoulder element (2) is arranged at the lower and upper ends of each of the vertical corners of containers stack, where the pillar element (1) has a smaller dimension as measured by the sum of the containers heights along a vertical corner of the container stack between the terminal shoulder elements (2), so that the boxes or containers absorb part of the load before the pillar element (1) comes into contact with the upper terminal shoulder.

### FIELD OF THE INVENTION

The invention relates to a reinforcement system and method for supporting boxes. Said reinforcement system and method are composed by a plurality of elements that interact together to collaboratively support with the boxes, the weight of the content of said boxes. The system allows to reduce the need of the use of boxes or contains configured with higher resistance materials.

### BACKGROUNDS

One of the main stages that are part of some industries corresponds to the transport of packed material. It is very frequent that the materials will be packed in containers or boxes made of different material and dimension, according to the contents and transported volume. Often said containers or boxes are usually transported in stacks, which present two main problems: damage over the container due to the weight of the containers stacked on said container and the difficulty of transporting the containers in motion, since they can slide or move from one of another.

In this way, the prior art intends to solve said problems in different manners. A solution of this type is the one disclosed by document WO2017086501 A1, which describes a packaging box having a post angle for reinforcing a packaging container integrally with a pallet. A pallet bracket which is fastened to the upper edge of the pallet and has a plurality of fastening holes at one side and a side fastening groove to be engaged with the post angle, the post angle standing on a corner of the pallet bracket and having a force bar on one side. The document also describes a container coupled to the post angle and defining an interior receiving portion with a wall surface; and a container cover covering the upper end of the container. The post angle comprises a bent portion provided at an upper end portion and having a grip portion for fixing the one side portion of the container to the container. It also includes an edge member provided on the outer surface of the container. Furthermore, it describes a vertical support comprising a vertical plate with a U-shape and a horizontal plate connected to a side of the vertical plate and contacting to upper end of the pallet.

Another solution is described by document KR101481638 B1 which discloses a packing box allowing on-site assembly. The box comprises reinforcing and supporting structures formed at respective corners of a box member whose four outer wall surfaces are connected by the corners, comprising an inner supporting member and an outer supporting member. The inner supporting member and the outer supporting member are fixed between them by a fixing clip which is a mean that can be easily attached to each corner of the rectangular box member. The fixing clip is inserted into the upper and lower portions of each corner of the box member in which the inner supporting member and the outer supporting member are disposed, and hence the inner edge of each corner. The inner supporting member and the outer supporting member are configured to adhere to each corner.

These solutions try to improve the structure of the box or container to support a greater stacking load, and at the same time, provide means that allow to secure one container with another. However, these solutions require the use specifically of said containers and they are not applicable for containers that do not have intrinsically installed reinforcing elements.

In this sense, the market presents solutions that can be implemented in containers that are not necessarily modified, which area mainly related to support the corners of stacked containers, in particular, carboard boxes

(https://www.youtube.com/watch?v=Q8XZTX4 nss&t=29s), wherein an element is arranged on an upper corner of a container, said element comprises a base in the middle portion allowing to receive the corner of an upper container. The element also comprises a clamp to secure the element on the lower container, without slipping during transport. However, this kind of solution does not allow stacking more than one column of stacked containers, since the structural unit of more than one column could not be maintained during transportation.

In conclusion, there is a need to implement a reinforcement system and method to support containers or boxes that allowing to maintain the structural unit of said stacked containers and that, in turn, allow that said containers support the load of the rest of the containers, without alteration that damage their content.

### SUMMARY OF THE INVENTION

The present invention is related to a reinforcement system and method composed by a series of elements that interact each and other to collaboratively hold with containers or boxes, the weight of the content it said containers or boxes. The system allows to reduce the need of having containers configured with higher resistance materials, since said system allows a better distribution of load over the containers, avoiding in this way the damage by the stacking weight and by any displacement that can be produced during the transportation.

The system is configured by three elements: pillar element; end shoulder element and, optionally, an intermediate shoulder element. The pillar element is configured as an elongated profile with a L-shape cross section, intended to maintain the structural unity of vertical corners of stacked containers. The intermediate shoulder element is configured as a profile with a L-shape cross section, whose inner part is symmetrically separated by a plane, said plane arranged in the central portion of the profile vertical respect to the internal surface of the profile. The end shoulder element is configured as a profile with a L-shape cross section, closed in one end.

The system work placing the end shoulder element on the upper and lower corners of the stack of boxes or containers and installing intermediate shoulder elements in intermediate zones of the stack, if necessary. Also, it is arranged a pillar of smaller dimension to the sum of heights of boxes or containers along one edge of containers stack between terminal shoulder elements, so the boxes or containers absorb part pf the load before the pillar contact the upper end shoulder element.

In an embodiment of the invention, when the stacking of more than one column of boxes or containers is required, it can arrange at least an internal column, which is arranged at the junction of four corners of boxes or containers. This junction comprises an upper and lower end supports and at least one pillar, similar as it was described before. End supports are conformed by a flat base and four pieces with a L-shape cross section. Said four pieces are vertically arranged respect to the flat base, conforming a cross-shape structure with a space between these pieces, wherein said space is arranged to the installation of pillars.

Finally, the step of placing straps or tying the system and the containers can be incorporated, so that the portion of the containers stack covered by the system is fixed or joined, and thus prevents the pillar elements from separating from the containers stack.

In this way, the described system allows the absorption of loads resulting from the stacking of one or more stacks of containers, without resulting in damage to the content and the containers themselves.

### BRIEF DESCRIPTION OF THE FIGURES

FIG. 1 represents a drawing in perspective view of the reinforcement system for one container section, according to an embodiment of the invention.

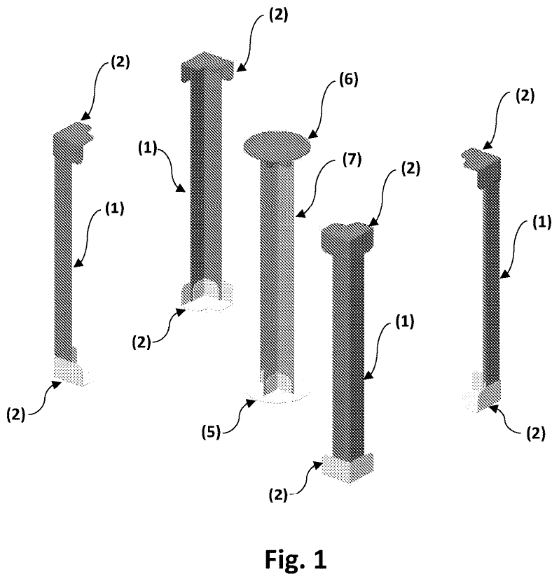

FIG. 2 represents a drawing in perspective view of the reinforcement system for at least two container sections, according to an embodiment of the invention.

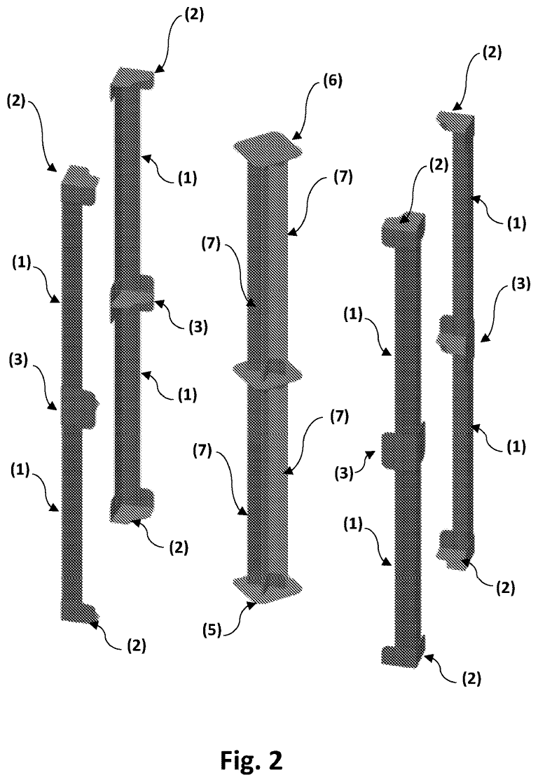

FIG. 3 represents a partial view of the reinforcement system showing intermediate shoulder elements and an intermediate support element, according to an embodiment of the invention.

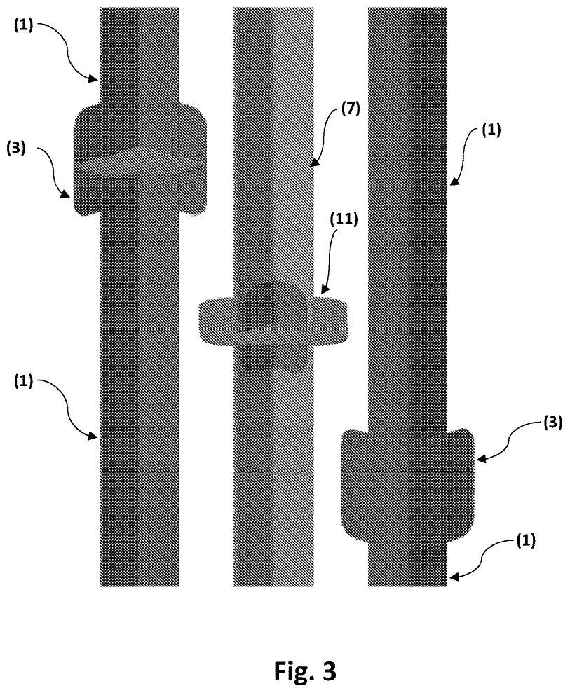

FIG. 4 represents a view of an intermediate shoulder element, according to an embodiment of the invention.

FIG. 5 represents a view of an intermediate shoulder element arranged together with two pillar elements, upper and lower, according to an embodiment of the invention.

FIG. 6 represents a view of an end shoulder element, according to an embodiment of the invention.

FIG. 7 represents a view of an end shoulder element arranged on the upper portion together with a pillar element, according to an embodiment of the invention.

FIG. 8 represents a view of an end shoulder element arranged on the lower portion together with a pillar element, according to an embodiment of the invention.

FIG. 9 represents a view of set of stacked boxes in a column, supported by end shoulder elements and one pillar element, according to an embodiment of the invention.

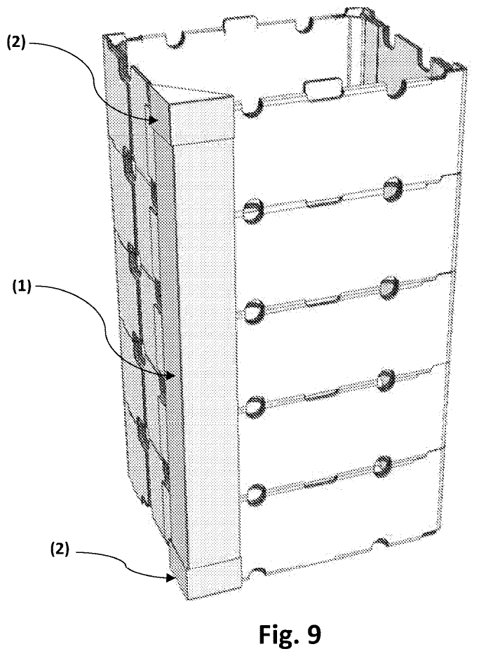

FIG. 10 represents a view of set of stacked boxes in six columns, supported by end shoulder elements, one pillar element and one intermediate shoulder element, as an example, according to an embodiment of the invention.

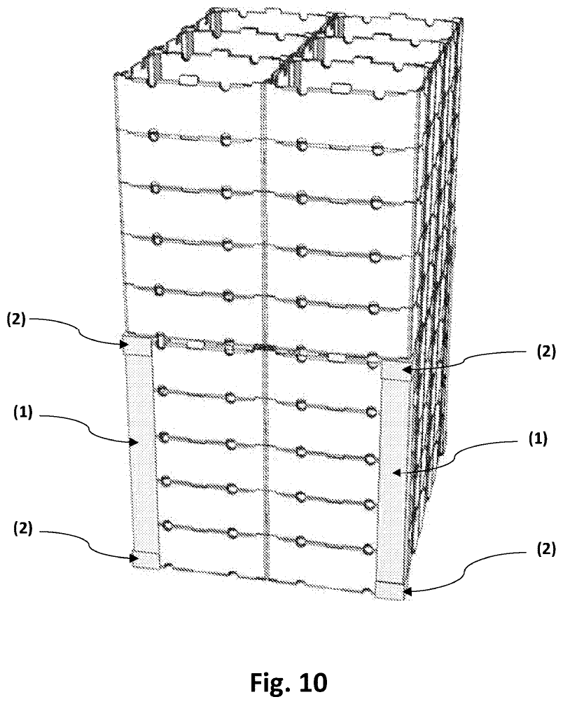

FIG. 11 represents a view of an end support for an internal column, according to an embodiment of the invention.

FIG. 12 represents a view of a lower end support for an internal column, according to an embodiment of the invention.

FIG. 13 represents a view of an internal column, according to an embodiment of the invention.

FIG. 14 represents a view of a set of stacked boxed in six columns, supported by end shoulder elements, one pillar element and one internal column, as an example, according to an embodiment of the invention.

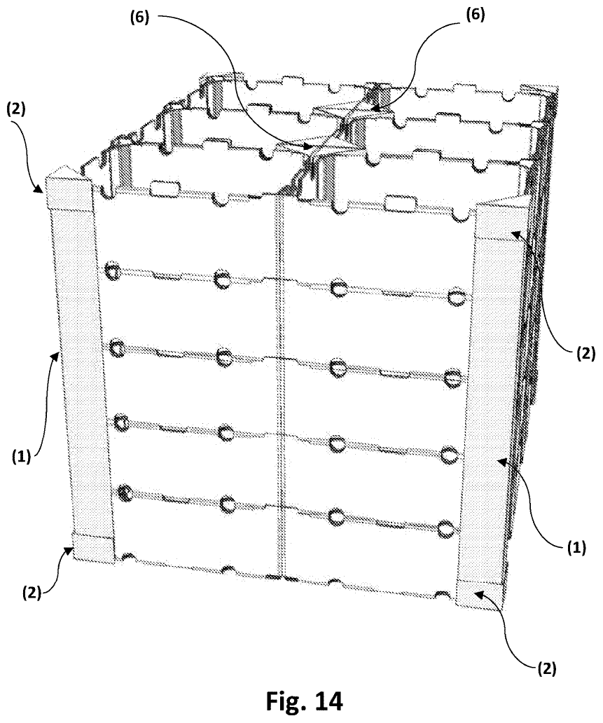

FIG. 15 represents a view of an intermediate shoulder element, according to an embodiment of the invention.

FIG. 16 represents a view of an intermediate support element arranged together with two pillars, according to an embodiment of the invention.

### DETAILED DESCRIPTION OF THE INVENTION

As detailed below, the reinforcement system consists of three elements: at least one pillar element (1), at least one end shoulder element (2) and, optionally, at least one intermediate shoulder element (3). Said elements are configured depending on the way of stacking of containers. That is, the elements to be use and their quantities will depend on the number of sections that make up the stack being defined by the number of roes that make up the containers.

In this way, each element contributes to maintain the structure of the container stack. The pillar element (1) allows to maintain the structural unit of various sections of containers stack along the vertical edges defined by said stack. The end shoulder element (2) allows the structural unit to be maintained at the lower and upper ends of each of the corners of the containers stack.

The intermediate shoulder element (3) allows to maintain the structural unit between consecutive container sections. Each intermediate shoulder element (3) is not necessarily installed in space between consecutive sections, but it can be installed in an intermediate portion of containers stack, depending on the requirement and the size of said stack.

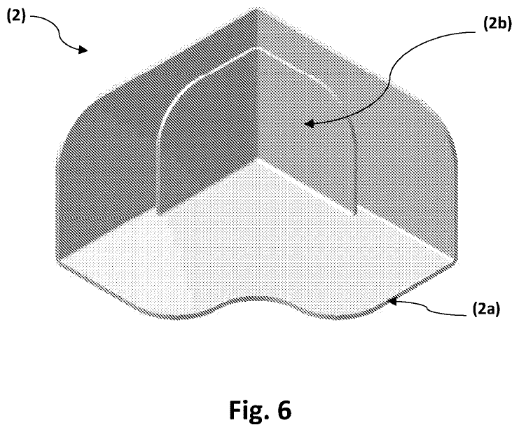

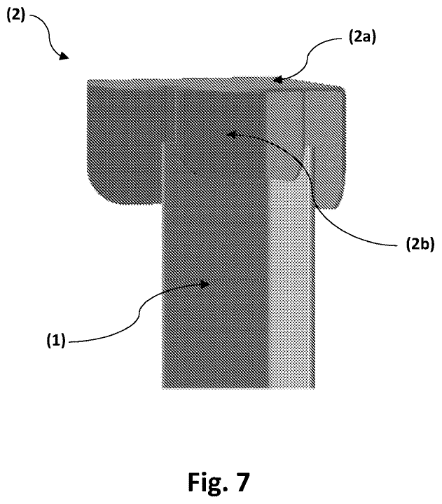

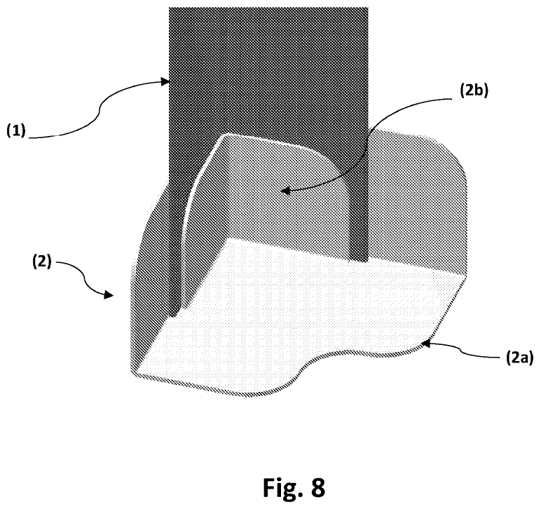

In one embodiment of the invention, the pillar element (1) is configured as an elongated profile with a L-shape cross section, wherein the length of said pillar element (1) depends on the size of the stack and where an intermediate shoulder element (3) is available. The end shoulder element (2) is configured as a profile with an L-shape cross section, where one of its ends is open and the opposite end is closed by a closure plate (2a). In the inside of end shoulder element (2) is arranged a clamping element (2b) of pillar element (1), said clamping element (2b) having a L-shape cross-section profile, whose dimension is less than or equal to the longitudinal dimension of the end shoulder element (2), as seen in FIG. 6. In this way, the pillar element (1) is inserted between the inner wall of the end shoulder element (2) and the clamping element (2b), thus maintaining the vertical position of the pillar element (1), as can be seen in FIGS. 7 and 8.

The end shoulder element (2) is arranged at each upper and lower corner of the container stack. In this way, the closure plate (2a) allows to limit the vertical movement of the container that is at the bottom of the containers stack and the container that is at the top of the containers stack.

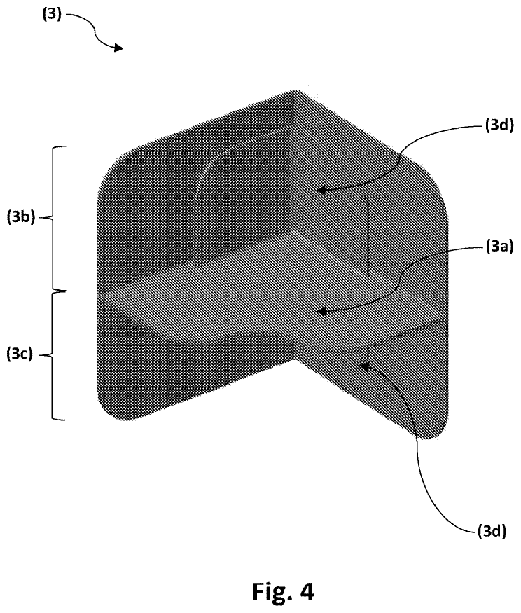

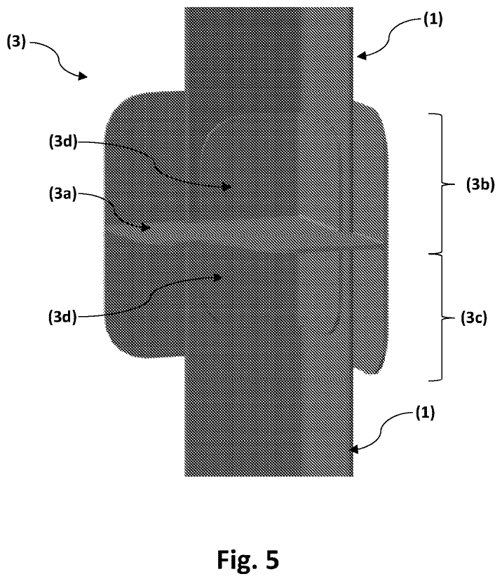

The intermediate shoulder element (3), as an optional element to be used, as can be seen in FIGS. 4 and 5, is configured as a profile with an L-shape cross section, wherein the inner part is symmetrically separated by a plate (3a), arranged in the central part vertically to the internal surface of the profile, thus defining an upper portion (3b) and a lower portion (3c), in such a way that the lower portion (3c) is placed on a upper corner of a container, resting on the plate (3a) and on the upper portion (3b) in a lower corner of a container, which rests on the upper part of the plate (3a). In this way, both consecutive containers are secured at the corners, to prevent horizontal movement relative to each other. In the upper portion (3b) and the lower portion (3c) of the intermediate shoulder element (3), a clamping element (3d) of pillar element (1) is arranged, which is shaped as a profile with a L-cross section, whose dimension is less than or equal to the longitudinal dimension of the intermediate shoulder element (3). In this way, the pillar (1) is inserted between the internal wall of the intermediate shoulder element (3) and the respective clamping element (3d), both in the upper portion (3b) and lower portion (3c), keeping, in this way, it fixes the vertical position of the pillar element (1), as can be seen in FIG. 5.

To assemble the system, as mentioned above, the number of sections or rows of containers that will be stacked must be defined to determine if the implementation of intermediate shoulder elements (3) is necessary. If this is the case, at least one intermediate shoulder element (3) is placed in intermediate zones, between two container sections. Then the end shoulder elements (2) are installed in each of the corners, at the top and at the bottom of the stack. Also, a pillar element (1) of smaller dimension to the sum of the heights of the boxes along one edge of the containers stack is placed between the end shoulder elements (2), so that the boxes or containers absorb part of the load before the pillar (1) makes contact with the upper terminal shoulder (2) and with the intermediate shoulder (3).

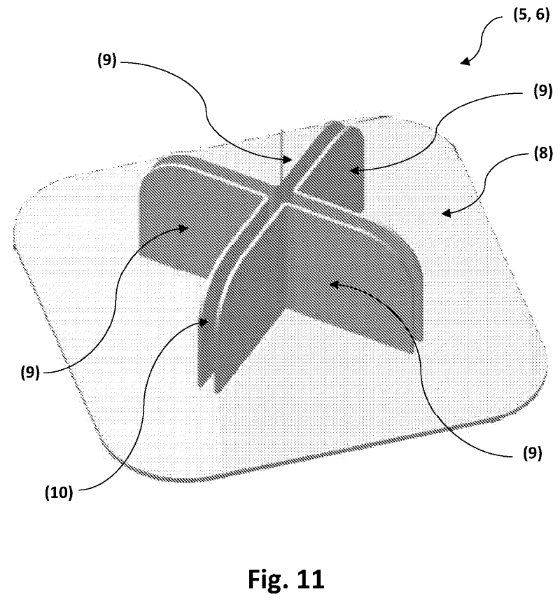

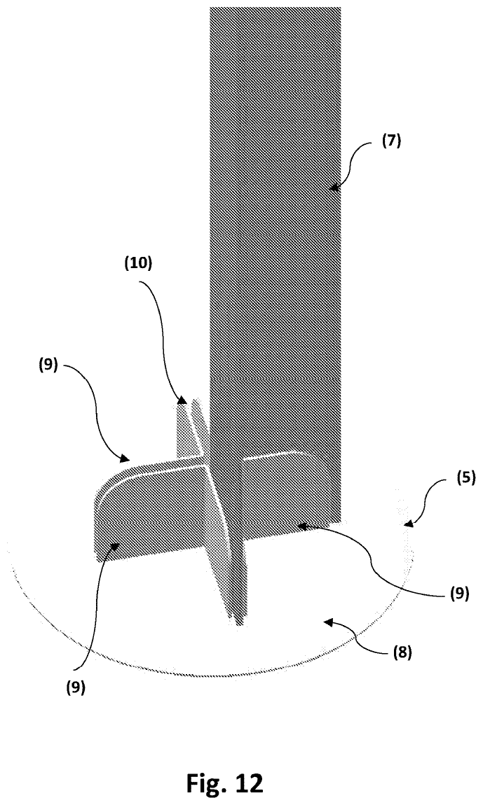

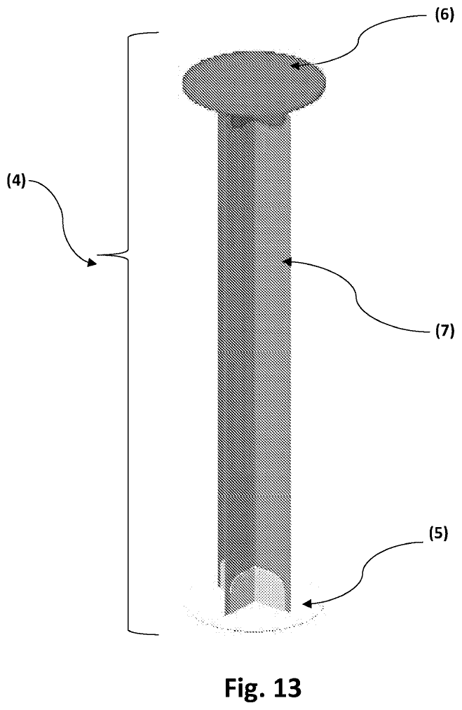

In one embodiment of the invention, when it is required to stack more than one column of boxes or containers that make up the stack, an internal column (4) can be provided, which is arranged at the internal junction of four corners of boxes or containers. This internal column (4) comprises a lower end support (5), an upper end support (6) and at least one pillar (7), as seen in FIG. 13. The end support elements (5, 6), as seen in FIG. 11, are identical and are made up of a flat base (8) and at least four support pieces (9), preferably formed as a piece of a profile with an L-shape cross section. Said four pieces are arranged in vertically to the flat base (8), forming a cross-type structure, maintaining a space (10) between them, where said space (10) is configured for mounting at least one pillar (7). In this way, the at least one pillar (7), whit a L-shape cross section, fits into the space (10) defined by the support pieces (9) of the flat base (8), as can be seen in the example illustrated in FIG. 12.

In this last embodiment, to assembly the system, the lower end support (5) is placed, subsequently the boxes are placed together with at least one pillar (7), which is fitted in the respective space (10) defined by the support pieces (9), where said at least one pillar (7) rests on the flat base (8) of the lower end support (5). After the containers are placed together with at least one pillar (7), the upper end support (6) is inserted in the upper part, so that at least one pillar (7) fits into the respective space (10) defined by the support pieces (6) of the upper end support (6).

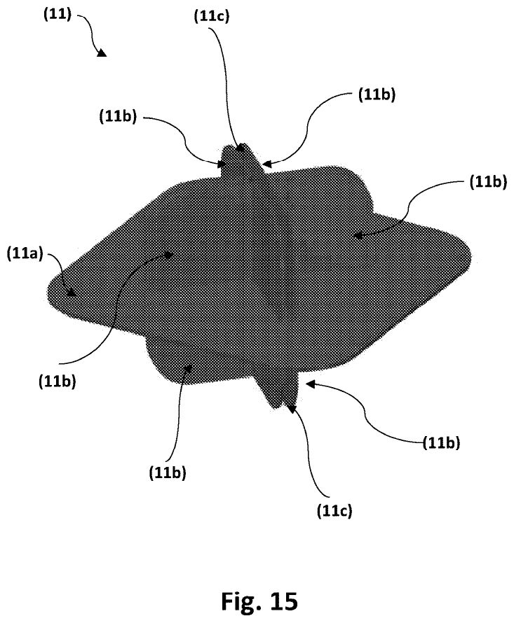

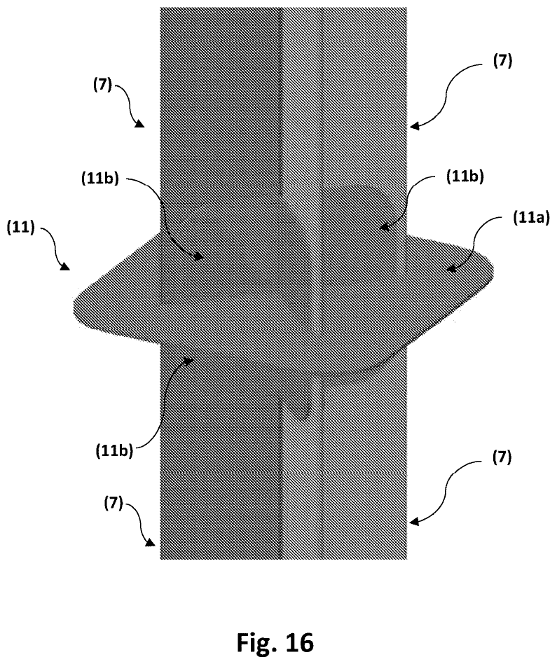

In one embodiment of the invention, in case of more container sections that make up the stack, at least one intermediate support element (11) can be arranged in the interior column (4). The structure of the intermediate support element (11) is similar to the structure of end support elements (5, 6) however, it has a symmetrical structure with respect to the cross structure. In this way, the intermediate support element is formed by a central plate (11a), which acts as a symmetry plane, where at least four support pieces (11b) are arranged on each of the sides of saidcentral plate (11a).), preferably shaped as profile pieces with L-cross section. Said four support pieces (11b) are arranged vertically to the central plate (11a) forming a cross-type structure, maintaining a space (11c) between them, where said space (11c) is configured for the assembly of at least one pillar (7), as shown in FIG. 15. In this way, the pillars (7), whose section is L-shaped, fit together in the space (11c) defined by the support pieces (11), on both sides of central plate (11a) symmetrically, as can be seen in the example illustrated in FIG. 16.

Finally, the step of placing straps or tying the system and the containers can be incorporated, so that the portion of the container stack covered by the system is fixed or joined, and thus prevents the pillar elements from separating from the stack. From containers.

In this way, the described system allows the absorption of loads collaboratively with the containers, product of the stacking of one or more containers stack, without resulting in damage to the content and the containers themselves.

### LIST OF REFERENCES

(1) Pillar element
(2) End shoulder element
(2a) Closure plate
(2b) Clamping element of pillar
(3) Intermediate shoulder element
(3a) Plate
(3b) Upper portion
(3c) Lower portion
(3d) Pillar clamping element
(4) Internal column
(5) Lower end support
(6) Upper end support
(7) Pillar
(8) Flat base
(9) Support pieces
(10) Support space
(11) Intermediate support element
(11a) Central plate
(11b) Support pieces
(11c) Support space

1. Reinforcement system for supporting stacked containers and boxes, without resulting in damage to the content and the containers themselves, comprising at least one pillar element (1) and at least one end shoulder element (2), wherein the at least one pillar element (1) is arranged on at least on corner of the containers stack, and wherein the at least one end shoulder element (2) is arranged at the lower and upper ends of each of the vertical corners of the container stack, CHARACTERIZED that the pillar element (1) has a smaller dimension that the sum of the container heights along a vertical corner of the container stack between the terminal shoulder elements (2), so that the boxes or containers absorb part of the load before the pillar element (1) makes contact with the upper terminal shoulder (2), and by comprising an internal column (4), which is arranged at the internal junction of four corners of boxes or containers, when the stack of containers comprises at least four columns of containers.

2. Reinforcement system for supporting stacked containers and boxes according to claim 1, CHARACTERIZED because pillar element (1) is configured as a L-shape cross section elongated profile.

3. Reinforcement system for supporting stacked containers and boxes according to any of previous claims, CHARACTERIZED because the end shoulder element (2) is configured as a L-shape cross section profile, where one of its ends is open and the opposite end is closed bay a closure plate (2a).

4. Reinforcement system for supporting stacked containers and boxes according to claim 2, CHARACTERIZED because a pillar clamping element (2b) of the pillar element (2) is arranged at the inner part of the end shoulder element (2), which is conform by and L-shape cross section profile, which dimension is less or equal to the longitudinal dimension of the end shoulder element (2).

5. Reinforcement system for supporting stacked containers and boxes according to any of previous claims, CHARACTERIZED by comprising at least one intermediate shoulder element (3), configured as a L-shape cross section profile, whose interior part is symmetrically separated by a plate (3a), arranged vertically in central part of the inner surface of the profile, thus defining an upper portion (3b) and a lower portion (3c), in such a way that the lower portion (3c) is placed on an upper corner of a container, resting on the plate (3a) and on the upper portion (3b) of a lower corner of a container, which rests on the upper part of the plate (3a).

6. Reinforcement system for supporting stacked containers and boxes according to claim 5, CHARACTERIZED by comprising a pillar clamping element (3d) arranged at the upper portion (3b) and the lower portion (3c), whose dimension es less or equal to the length of intermediate shoulder element (3).

7. Reinforcement system for supporting stacked containers and boxes according to any of previous claims, CHARACTERIZED because the internal column (4) comprises a lower end support (5), an upper end support (6) and at leaser a pillar (7).

8. Reinforcement system for supporting stacked containers and boxes according to any of previous claims, CHARACTERIZED because the end supports (5, 6) are identical and are formed by a flat base (8) and by at least four support pieces (9), formed as a piece with a L-shape cross section.

9. Reinforcement system for supporting stacked containers and boxes according to any of previous claims, CHARACTERIZED because said four pieces are arranged vertically to the flat base (8), forming a cross-type structure, maintaining a space (10) between these four pieces, where said space (10) is configured for the assembly of the at least one pillar (7), allowing said at least one pillar (7), whose L-shape cross section fit into the space (10) defined by the support pieces (9) of the flat base (8).

10. Reinforcement system for supporting stacked containers and boxes according to any of previous claims, CHARACTERIZED by comprising at least one intermediate support element (11), made up of a central plate (11a), which acts as a plane of symmetry, wherein on each of the sides of said central plate (11a) at least four support pieces (11b) are arranged, preferably shaped as L-shape cross section profile, where said four support pieces (11b) are vertically arranged to the central plate (11a) forming a cross-type structure, maintaining a space (11c) between these four support pieces (11b), where said space (11c) is configured for mounting the at least one pillar (7).

11. A method of assembling a reinforcement system to support stacked containers or boxes, without resulting in damage to the content and containers themselves, CHARACTERIZED by comprising the steps of:
a. place at least one end shoulder element (2) in the corners of the bottom of the stack;
b. place containers on said at least one end shoulder (2) placed at the bottom of the stack;
c. place at least one pillar element (1) on the lower end shoulder (2), and in at least one corner of the stack formed by the containers; and
d. place at least one end shoulder element (2) in the corners of the top of stack, where the pillar element (1) ends,
where the pillar element (1) has a smaller dimension as measured by the sum of the container heights along a vertical corner of the container stack between the end shoulder elements (2), so that the boxes or containers absorb part of the load before the pillar element (1) makes contact with the upper end shoulder (2); and it further comprises the step of placing an interior column (4), which is arranged at the internal junction of four corners of boxes or containers, when the containers stack comprises at least four columns of containers.

12. The method of assembling a reinforcement system according to claim 11, CHARACTERIZED in that the steps of placing the pillar element (1) in the respective end shoulder elements (2) comprise inserting the end of the pillar element in a clamping element of pillar (2b) of the end shoulder element (2), which is a L-shape cross section profile, the dimension of said clamping element is less than or equal to the longitudinal dimension of the terminal shoulder element (2).

13. The method of assembling a reinforcement system according to claims 11-12, CHARACTERIZED, further comprising the step of placing an intermediate shoulder element (3), which is configured as a L-shape cross section profile, whose inner part is symmetrically separated by a plate (3a), arranged vertically in the central part to the internal surface of the profile, thus defining an upper portion (3b) and a lower portion (3c), in such a way that the lower portion (3c) is placed on an upper corner of a container, resting on the plate (3a) and on the upper portion (3b) on a lower corner of a container, which rests on the upper part of the plate (3a).

14. The method of assembling a reinforcement system according to claims 11-13, CHARACTERIZED in that the step of placing an interior column (4) comprises the following stages:
a) Place a lower end support (5) at the bottom of the stack;
b) Placing at least one pillar (7) in a cross-shaped support space (10), defined by at least four support pieces (9) placed on a flat base (8) of the lower end support (5); and
c) Place an upper tend support (6) on top of the stack, fitting the upper ends of the at least one pillar (7) in a cross-shaped space (10), defined by at least four support pieces (9) placed on a flat base (8) of the upper end support (6).

15. The method of assembling a reinforcement system according to claims 11-14, CHARACTERIZED in that the step of placing an interior column (4) further comprises incorporating an intermediate support element (11), made up of a central plate (11a), which acts as a plane of symmetry, where on each of the sides of said central plate (11a) there are at least four support pieces (11b), preferably pieces with L-shape cross-section profile, where said four pieces of support (11b) are arranged vertically to the central plate (11a) forming a cross-type structure, maintaining a support space (11c) between them, where said support space (11c) is configured for mounting the at least one pillar (7), where the at least one pillar (7) fits into the support space (11c) defined by the support pieces (11b), on both sides of the central plate (11a) symmetrically.

16. The method of assembling a reinforcement system according to claims 11-15, CHARACTERIZED in that it comprises the step of placing straps or tying the system and the containers, so that the portion of the containers stack covered by the system is fixed or attached, and thus prevents the pillar elements from separating from the containers stack.
